(19) United States
(12) Patent Application Publication
(10) Pub. No.: US 2011/0218824 A1
(43) Pub. Date: Sep. 8, 2011

(54) Patient-Physician Connectivity System and Method

(75) Inventors: Christ J. Pavlatos, Gurnee, IL (US); Michael J. Pavlatos, Gurnee, IL (US)

(73) Assignee: PatientMD, Inc., Chicago, IL (US)

(21) Appl. No.: 13/084,703

(22) Filed: Apr. 12, 2011

Related U.S. Application Data
(63) Continuation-in-part of application No. 10/595,011, filed on Mar. 8, 2007.
(60) Provisional application No. 60/501,298, filed on Sep. 8, 2003.
(60) Provisional application No. 61/323,568, filed on Apr. 13, 2010.

(51) Int. Cl. G06Q 50/00

(52) U.S. Cl. 705/3

(57) ABSTRACT

A computerized system and method for allocating payments for access to a computer system. In some embodiments, the method includes the step of storing a personal health record (“PHR”) of a patient including a plurality of records with medical information concerning the patient in a database. The database may include at least one record identifying a primary care physician (“PCP”) of the patient. A charge is established for patient access to the PHR and the patient is required to pay at least a portion of the charge. After receipt of the payment, the patient is provided with access to the PHR over a communication network. An allocation of the payment is determined between a plurality of entities including the PCP of the patient. At least a portion of the payment is allocated to the PCP, regardless of whether the PCP issued the PHR to the patient. This allocated allow is then paid to the PCP.

### RELATED APPLICATIONS

This application is a continuation-in-part of U.S. application Ser. No. 10/595,011, filed Dec. 15, 2005, which is the national stage application of PCT/US04/29161, filed Sep. 8, 2004, which claimed the benefit of U.S. Provisional Application Ser. No. 60/501,298, filed Sep. 8, 2003. This application also claims the benefit of U.S. Provisional Application Ser. No. 61/323,568, filed Apr. 13, 2010. These applications are hereby incorporated by reference in their entireties.

### BACKGROUND AND SUMMARY

Many diverse medical record and medical information management systems are found in the art. Such systems provide access and retrieval of particular categories of patient or medical information, such as for example, insurance information use insurance information management systems, lab results or reports are accessible from laboratory information systems (LIS), patient records are managed on hospital information systems (HIS), and clinical data is stored in Clinical Data Repositories (CDR). The degree to which information has been shared between such healthcare information systems has to this point been limited. Also, patients have been unable to find a centralized, integrated interface for accessing information from these disparate healthcare data systems.

Further, these decentralized medical information management systems have been unable to communicate, or such communication has been unworkable due to the business environment which was better suited to autonomous providers of such information services. Technological advances in encryption, regulatory changes to patient privacy laws, and advances in the communications infrastructure has been lacking to the extent that a global, integrated network for accessing all of these data sources contemporaneously has not been possible.

Further, there has up to now been lacking a system that provides functionality for the physician based on the information in a patient's health record. A number of tasks may be simplified and/or automated by having a health record system review information in the health record, prior to or during review of the health record by a physician.

Briefly, and in accordance with the foregoing, disclosed is a system and method for providing health assistance based on information in a patient's health record. An interface is provided for providing assistance which includes a patient health record section and a banner section that performs health assistance-related functions based on the content of the patient health record section.

Additional features will become apparent to those skilled in the art upon consideration of the following detailed description of drawings exemplifying the best mode as presently perceived.

### BRIEF DESCRIPTION OF THE DRAWINGS

The detailed description particularly refers to the accompanying figures in which:

FIG. 1 is a simplified diagrammatic flowchart generally depicting the components of the current system;

FIG. 2 is a simplified diagrammatic flowchart representing dataflow among the various components and users of the current system;

FIG. 3 illustrates one embodiment of an interface for the current system;

FIG. 4 illustrates one embodiment of an MD working page;

FIG. 5 illustrates one embodiment of an interface for connectivity to a physician's hospitals accessed via the working page;

FIG. 6 illustrates one embodiment of a Patient's Medical Records page that allows selection among various medical records sources accessed via the working page;

FIG. 7 illustrates one embodiment of an Evidence Based Medicine page accessed via the working page;

FIG. 8 illustrates one embodiment of a Preventative Medicine Services page accessed via the working page;

FIG. 9 illustrates one embodiment of a direct target marketing prescription order form accessed from a banner on the working page;

FIG. 10 illustrates one embodiment of a Medication History page accessed from the working page;

FIG. 11 illustrates one embodiment of a Patient Images page accessed from the working page;

FIG. 12 illustrates one embodiment of a working page showing an alert banner;

FIG. 13 illustrates one embodiment of an MD Personal page;

FIG. 14 illustrates one embodiment of Patient Lab Results page;

FIG. 15 illustrates one embodiment of the Patient Lab Results page of FIG. 14 showing drop down menu for a patient's contact information;

FIG. 16 illustrates one embodiment of an Office Staff Registration page;

FIG. 17 illustrates one embodiment of an Office Staff Billing page;

FIG. 18 illustrates one embodiment of a patient personal page;

FIG. 19 illustrates one embodiment of a Medical History page accessible from a patient's personal page;

FIG. 20 illustrates one embodiment of a Medication Listing on a patient's personal page;

FIG. 21 illustrates one embodiment of Consumer Portal page;

FIG. 22 illustrates one embodiment of screen for requesting healthcare for uninsured patients accessible from the Consumer Portal page; and

FIG. 23 illustrates one embodiment of a method for allocating payments for access to the patient's PHR.

### DETAILED DESCRIPTION OF THE DRAWINGS

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

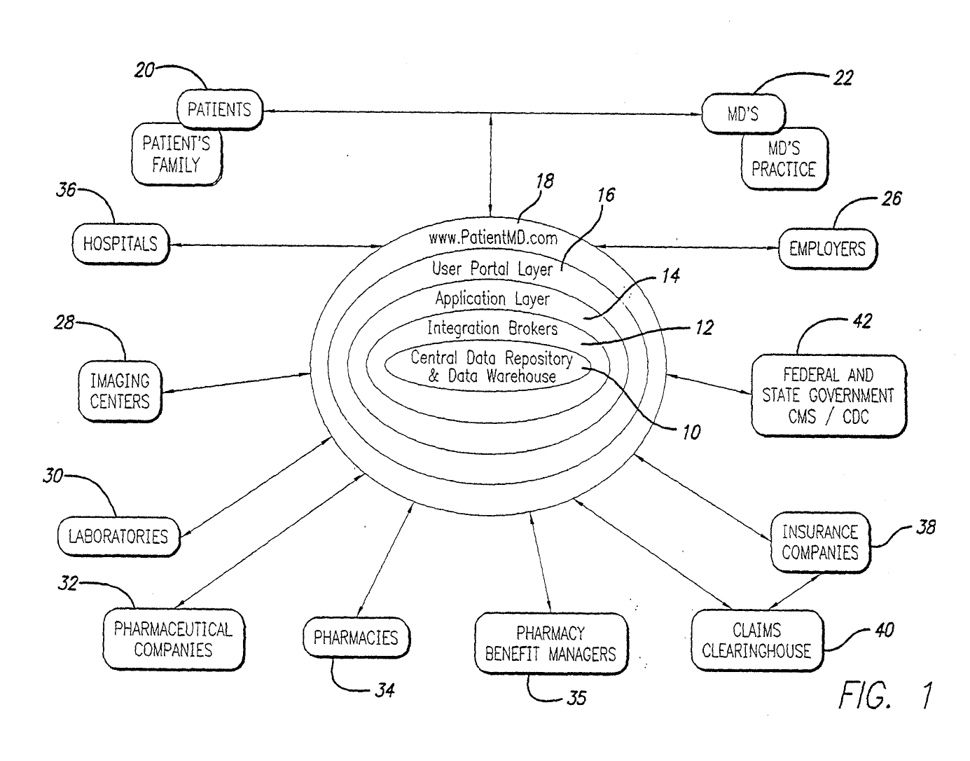

With reference to the figures, FIG. 1 shows the components and health-related information providers comprising and connected to the current system. The system is built around a database of health-related information or central data repository 10, hereinafter referred to as the repository 10. The repository 10 is a database linking all the relevant medical-related information for each member patient. For purposes of this disclosure, medical-related or health-related information includes but is not limited to medical history, medical profile information, lifetime laboratory reports, demographic information, current and past prescribed medications, insurance coverage information, and family medical history. The term member patient is any person who is receiving healthcare services from a healthcare provider who offers the functions of the current system and allows the patient access to the information stored therein.

The repository 10 is a server or server cluster capable of providing high speed access and retrieval over a communications network such as the Internet, and may be constructed from any enterprise quality server known in the industry. The repository is connected to the communications network with a connection having bandwidth suitable for generally simultaneous and continuing access and updating from the medical-related information providers shown in FIG. 1 and described hereinafter, such as by a T3 line or other suitable high bandwidth connection.

To provide compatibility between various existing and possibly future networks used by the medical-related information providers, one or more integration brokers 12 may be utilized. The integration brokers 12 may also provide application layers 14 to the various medical-related information providers, which will be customized for the information retrieved or provided by them. Integration brokers 12 may also assist in consolidating hospital data and delivering data to the CDR. One example of the application layer 14, is the user portal interface 16 which is used by individual physicians and/or patients. User portal interface 16 uses a commonly available web browser interface such as is supported by Microsoft Internet Explorer and Netscape Navigator. As an example, in the future, the user interface 16 may be accessed at the domain name address www.patientmd.com 18, currently controlled by the assignee of the present application.

As shown in FIG. 1, medical-related information providers that communicate with the repository 10 include but are not limited to hospitals 36, imaging centers 28, laboratories 30, pharmaceutical companies 32, pharmacies 34, pharmacy benefit managers 35, claims clearinghouses 40, insurance companies 38, federal and state government organizations or agencies such as the Centers for Medicare and Medicaid Services (CMS) and the Center for Disease Control (CDC) 42.

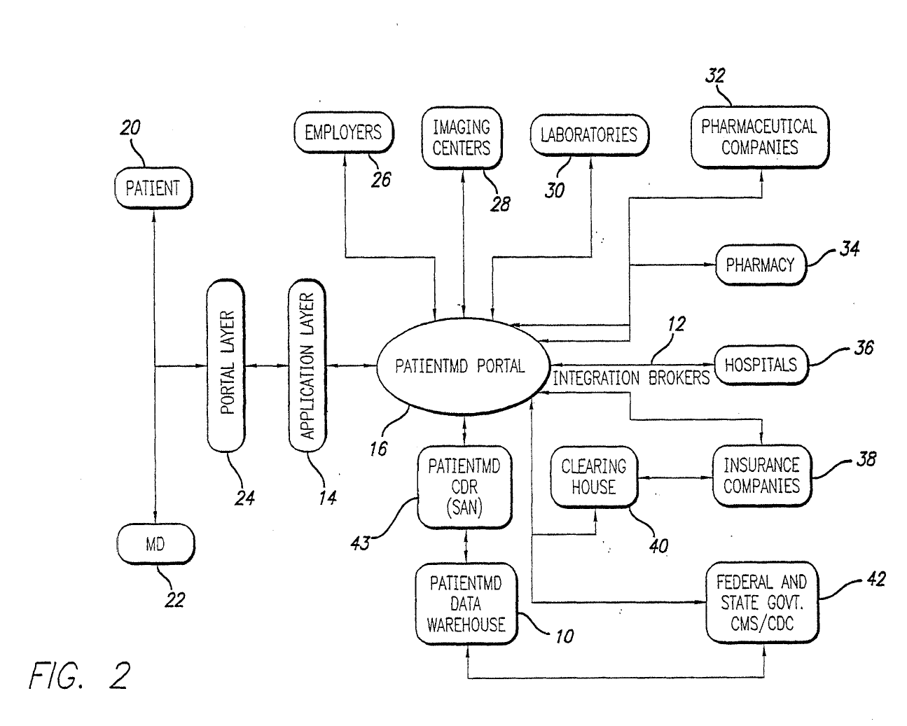

FIG. 2 shows a simplified diagrammatic flowchart representing how medical-related information flows between components and users of the current system. Patients 20 and doctors 22 access the portal 16 via a portal layer 24 and application layer 14. Data may be requested and delivered using commonly available protocols such as TCP/IP with security provided with a Secure Socket Layer (SSL) protocol or the like. It is envisioned that other security measures, such as the use of soft and hard tokens and biometrics and smart card technology, can be used in conjunction with the current system as well. As discussed previously, pursuant to privacy considerations and regulations such as the Health Insurance Portability and Accountability Act (HIPAA), each medical-related information provider or user, including employers 26, imaging centers 28, laboratories 30, pharmaceutical companies 32, pharmacies 34, hospitals 36 via integration brokers 12, insurance companies 38, and federal and state government organizations 42 can access information relevant to each provider or user via the portal 16. Insurance companies 38 also communicate with or through clearing houses 40 for processing and management of insurance claims.

The portal 16 is connected via the storage area network (SAN) 43 to the repository or data warehouse 10 which may also be connected directly to the government organizations 42 to perform the functions described below or could perform the functions as a software service, such as using cloud computing technology.

The consolidation of clinical and/or administrative patient data described in the above system from in-patient (such as hospital), out-patient, or ambulatory settings including physician offices, dental facilities, private ancillary services like physical therapy centers, imaging centers, and nursing homes is delivered to providers of healthcare such as physicians, nurses, dentists, and hospital personnel on a commonly shared infrastructure. The term “physician” or MD may be used in this disclosure and is intended to refer to any type of healthcare provider. The data is delivered to physicians in a single common user interface.

The consolidation also allows the healthcare provider's patient medical records, either in structured data created by their electronic medical record, or from inputted text data, to be integrated with data from other medical-related sources to create a comprehensive computerized patient record.

One aspect of the current invention is the functionality provided by the physician's version of the portal. The physician's portal is generally divided into two units: the MD's working page and the MD's personal page. The MD's working page, via a web browser interface of known construction, allows a physician to log in and select a patient through a scheduling module to view basic patient data in summarized form, hereinafter referred to as patient's “Medical Summary,” and change the information if necessary. The term “module” referenced in this disclosure is meant to broadly cover various types of software code including but not limited to routines, functions, objects, libraries, classes, members, packages, procedures, methods, or lines of code together performing similar functionality to these types of coding used to enable a processor to perform tasks specified by the module.

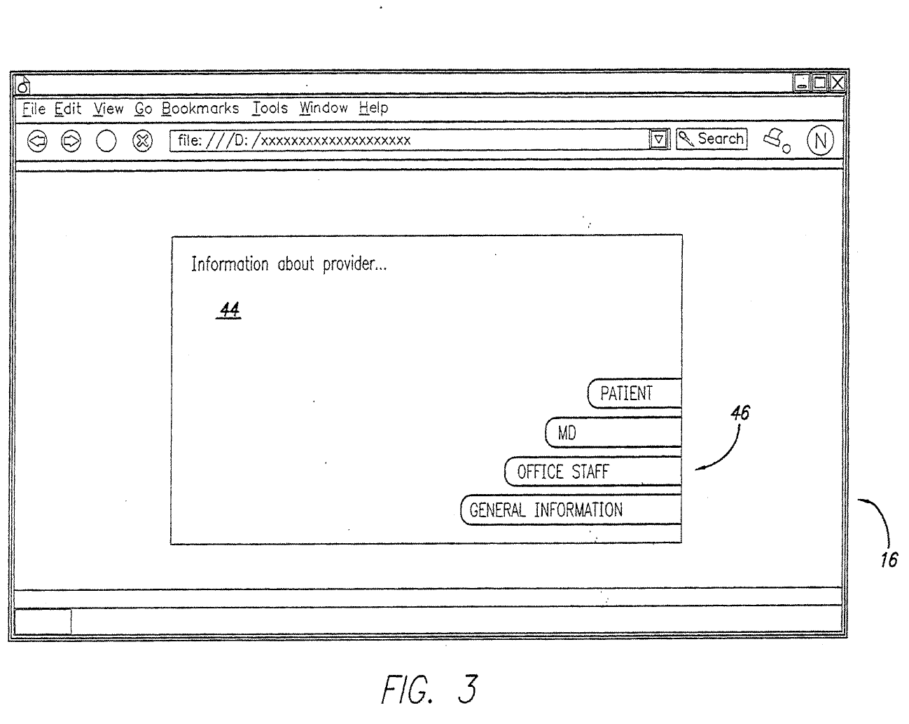

FIG. 3 is an example of user portal interface 16. This example shows information about the provider of the portal in an informational section 44, which may include information specific to a city or state. Along the right side of the interface 16 shown, are four links 46 which forward to customized portals based on the type of user wishing to access the system. The interface 16 shown in FIG. 3 shows, as an example, links to a “Patient” section, an “MD” section, an “Office Staff” section, and a “General Information” section. The term “section” referenced in this disclosure describes a portion of the interface in which functions are grouped based on a particular task or category of information.

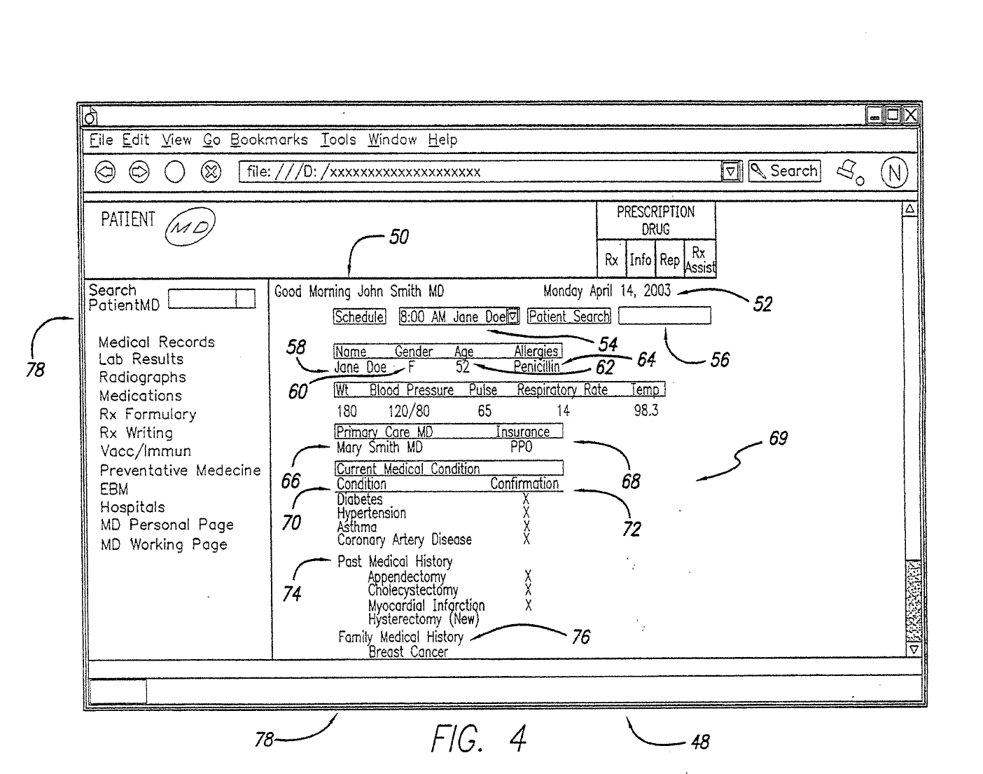

FIG. 4 illustrates an MD or physician's working page 48. A physician identifier and greeting 50 is shown at the top of the page next to the current date 52. The elements shown on these pages may be arranged in alternative orientations and still be within the scope of this disclosure. The next element is schedule selection drop down box 54 which allows a user physician to select a particular patient/appointment combination. As an example, an 8:00 AM meeting with patient Jane Doe is shown. Although a drop down box is shown, other commonly found selection techniques, such as pop-up menus and radio buttons may be used as well. Another element on the MD working page 48 is patient search query box 56 into which the user-physician can input a search screen to find a particular patient.

Information about the selected patient is also displayed on the screen and includes the patient's name 58, gender 60, age 62 and a listing of the patient's allergies 64. The patient's primary care doctor 66 and insurance provider 68 may also be identified. This information is presented in a simple interface for convenient and efficient reference.

The working page 48 also includes a current medical condition section 69 which lists the selected patient's current medical conditions 70, with a corresponding confirmation column 72 indicating that a listed condition has been confirmed. The working page 48 also includes a past medical condition section 74 similarly listing past medical conditions along with confirmation indicators. A listing of the patient's family medical history conditions 76 is also presented.

The user-physician can browse and/or update this information before, during, or after a patient consultation. The user-physician can also progress to other pages of the portal by clicking on a page link in the page link selection section 78. In addition, it is envisioned that from the working page 48, the physician-user can receive requests for telemedicine services from their patients or potential patients. Typically, the working page 48 is a single community wide electronic health record (EHR) of the patient with input from multiple providers. Also, the telemedicine capabilities can be used to request a second opinion from another physician or to allow the physician-user to give a second opinion to other physician-users.

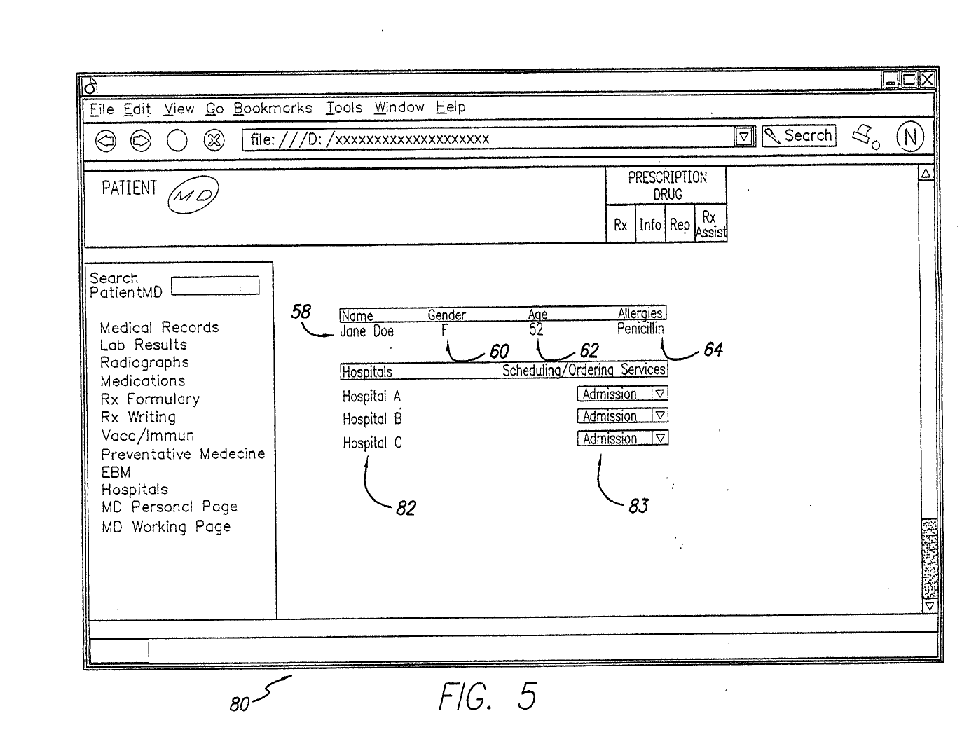

FIG. 5 illustrates an interface 80 of the physician's working page that allows access to the physician's hospitals. Patient information 58, 60, 62, 64 is shown in addition to a listing of hospitals 82 and associated selection boxes 83 for selecting whether to schedule or admit the patient to those hospitals for one or more treatments.

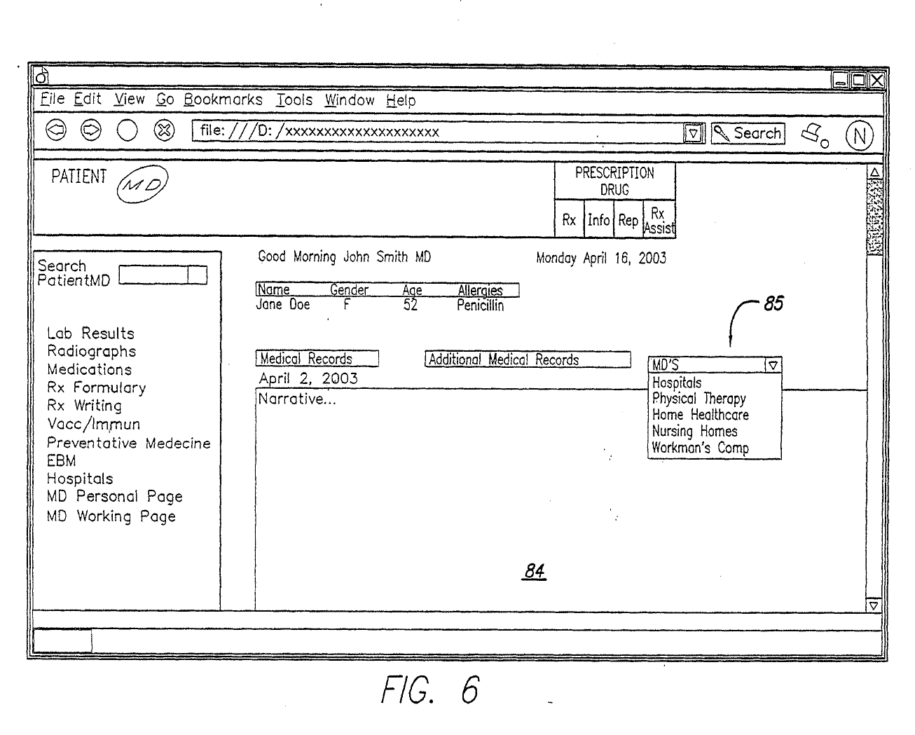

FIG. 6 illustrates a Patient's Medical Records page 84 which allows a physician to access a patient's medical records from a selection of sources by using a drop down box 85. These other sources may include but are not limited to other doctor's office's records, hospitals, physical therapy facilities, home healthcare services, nursing homes, and workman's compensation forms. By default, a patient's medical records from a logged on physician will be displayed but records from other physicians, and the other sources are available by being clicked or otherwise selected.

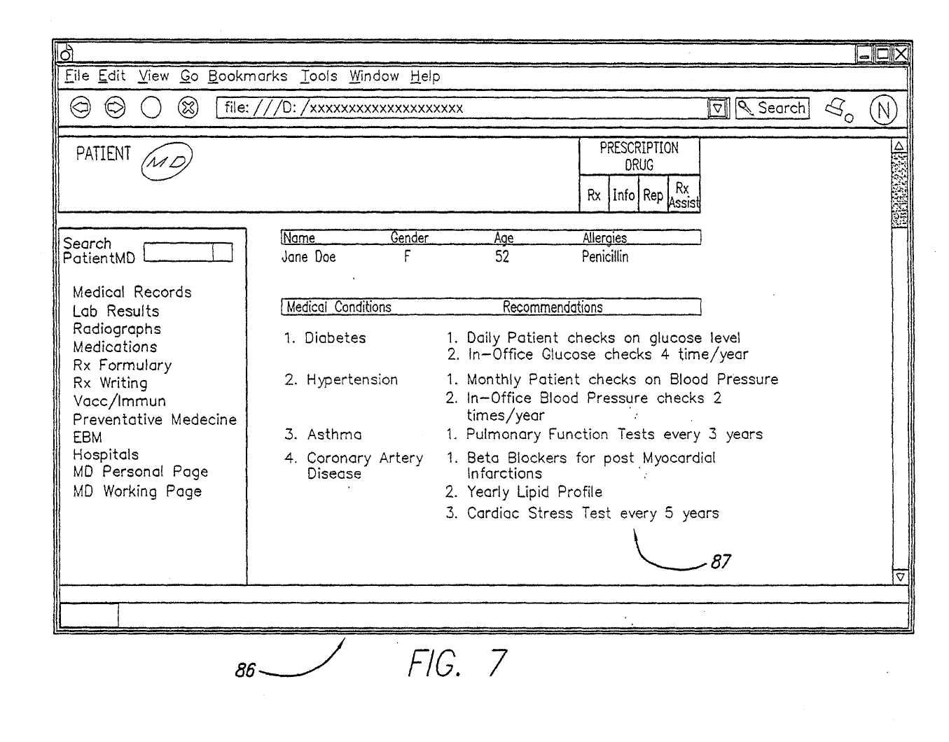

FIG. 7 illustrates an evidence based medicine (EBM) page 86. EBM and preventative medicine, or “PM”, are services or medical advice that are specific to each patient. The exact recommended service for each patient will be based on the information in each patient's Medical Summary. As data is entered into the Medical Summary, by either patients or physicians, the services change based on protocols for PM and EBM established by sources such, by way of example but not limitations, medical societies, for each specific disease or ailment.

The system's ability to provide information about and monitor PM and EBM makes the system useful to employers as well, who are concerned about lowering their premiums by showing insurers that the employers are taking steps to improve employee health. One illustrative example is that it is expected that in the future, employers who do not offer PM and EBM incentives will have to pay higher healthcare premiums. Another illustrative example is the benefits to employer's Defined Contribution Programs if patients begin to choose this service. Defined Contribution Programs provide employees a Medical Savings Accounts. Patients can chose to spend this money for designated health care services. Based on recent IRS rulings, any money not used by the end of the year can roll over (if the employer wishes to set the service up that way) tax free like a 401K Health Account. It is expected that employers may elect to allow funds to carry over only if the patient has practiced PM and EBM services. Employers may use the prevention, wellness services based on evidence based medicine protocols to provide variable financial incentives to patients based on their compliancy and their insurance product. Employers can use the EBM and PM monitoring provided by the current system to monitor employee compliance. This produces the societal benefit of having a patient become an active participant in his or her own healthcare.

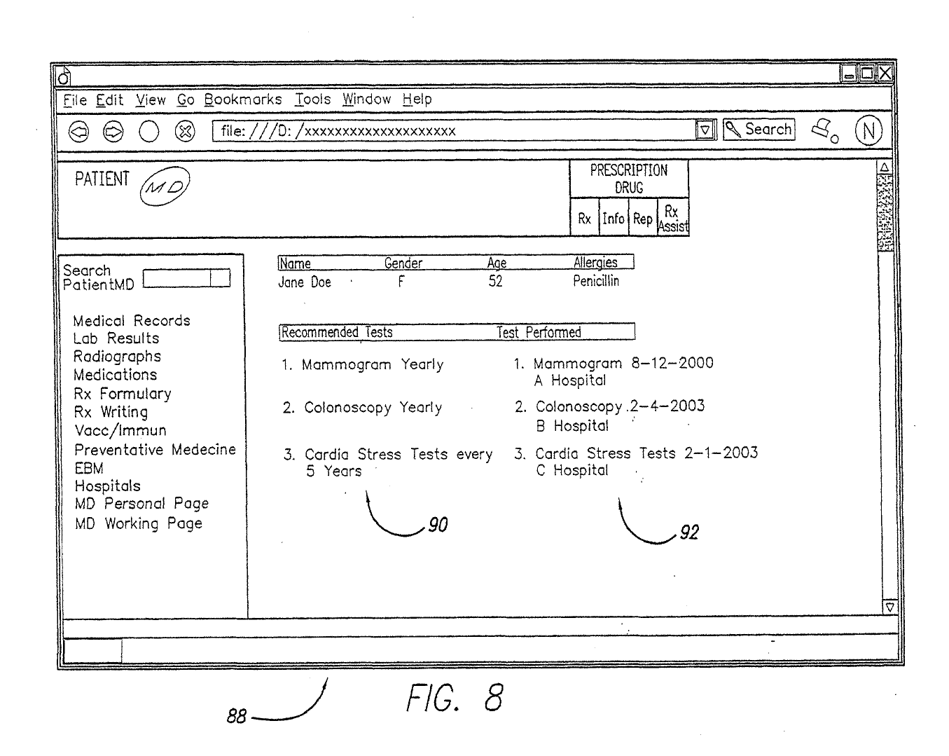

As shown in FIG. 7, the EBM page 86 includes a recommendations section 87, that shows one or more established medical society's recommendations for each medical condition. Similarly, FIG. 8 illustrates a PM page 88 which shows a listing of recommended tests 90 for the selected clients along with a corresponding historical tests performed listing 92 which includes the date and hospital where that test was performed.

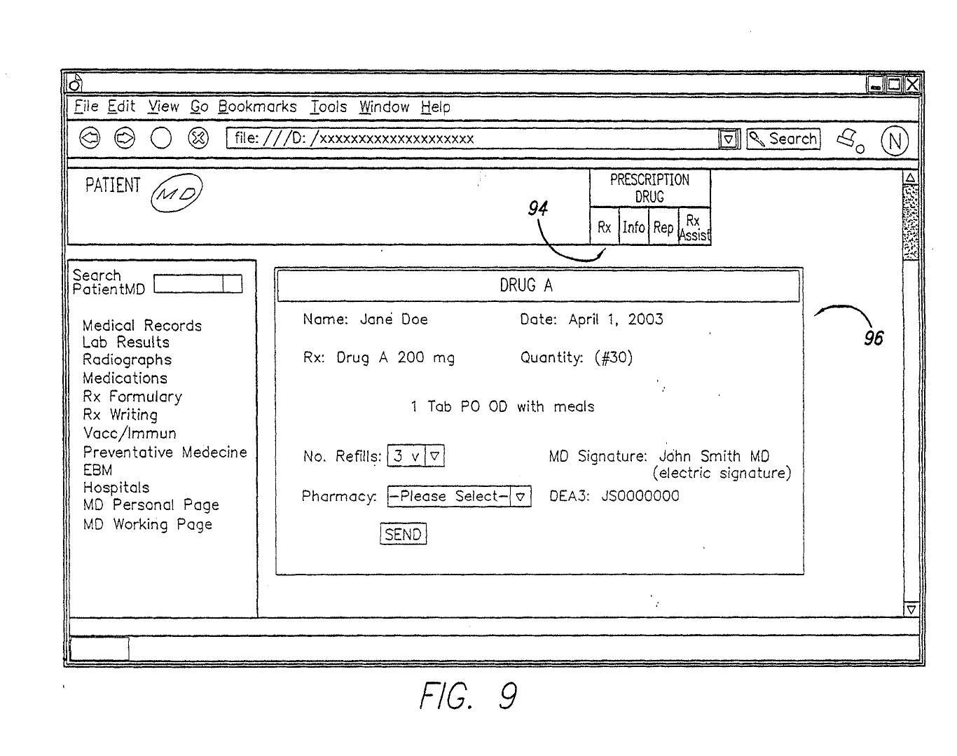

The current system also provides useful functionality to physicians using their working pages and other pages while the physician is with the patient and other times. The time with when a physician is with the patient is referred to as point of service care. This assistance is provided via the web-based interface shown in FIG. 9. For example, at the point of service, a physician can click on a functional banner or banner section 94 shown at the top of the page in FIG. 9, although other locations for the banner may be selected as well. This is referred to as Point of Care (POC) service. The banner may provide a number of different functions including the following. The functional banner 94 may call a screen that allows the physician to take a prescription-related action. Prescription-related action include but are not limited to ordering a prescription, writing a prescription, obtaining information about a drug, and other actions. The particular action may be based on customized settings and be based on the physician's specialty and/or likelihood for prescribing the medication. Generally the interface shown in FIG. 9 incorporates the patient health record information described above, with some action available via the banner. The patient health-related information may be shown in various form via any of the “pages” described above, and is referred to collectively as a patient's patient health record section. The banner 94 and various functions launched by the banner 94 are referred to as the banner section. The banner section generally displays information or messaging which may take the form of text, graphics, sounds, or other messaging based on the content of one of the fields or other content of the patient health record section.

A first function is prescription ordering which allows a physician to create an automated prescription for a patient via a prescription ordering template. FIG. 9 shows one such prescription ordering template 96. The interface of FIG. 9 may also be used to generate a product ordering page. The term product is intended to broadly cover any type of product or services recommended, prescribed, or otherwise mentioned by a physician, including but not limited to prescription drugs, over-the-counter drugs, health aids, vitamins, medical equipment, medical devices, foods, beverages, and health products. It is envisioned that products ordered by this interface may be pre-packaged or pre-staged at a selected product seller or distributor for pick-up by a patient and may include medical services, medical devices, etc.

A second function is retrieving prescription or drug information which will be available for the physician to review, print, or email to a patient's health record (PHR). The drug information may include, but is not limited to, illness that can be treated with a particular drug, dosage, effectiveness, side effects, costs, and other information.

A third function is that a physician can click on a banner to automatically connect, or to schedule a connection, to an audio, visual, or other interactive conference with a drug company's representative. For this function, the banner may become, or upon being clicked launch, an audio-visual portal for hosting the communications session. The drug company's representative or other provider, including a drug whole-seller, reseller, or other distributor, may be selected based on the information in the patient health record section and/or the physician's preferences.

A fourth function is connectivity to drug assistance programs provided by various pharmaceutical companies for patients that cannot afford the medication the physician-user is considering prescribing. Drug assistance programs are unknown to many physicians or underutilized because of the time and effort to complete the forms. The current system may use an Enterprise Master Patient Index (EMPI) and stores demographic information on the patient which allows patient information to automatically be generated in drug assistance program request forms. Therefore, this service can be provided when the patient is still present in the physician's office which means it is more likely to be used to the patient's benefit. To perform this task, the banner 94 may display a drug assistance request template or form that may be automatically populated with the patient's health information.

A fifth function of the banner is to allow a physician-user to customize the banner 94 to shows drugs or drug-related advertising the physician-user wants displayed based on experiences with such drugs or other reasons. For example, the physician can choose one of ten drugs he or she may wish to have on their drug list banner. This process allows the physician-user to control the direct target marketing at the point of service based on the physician-user's own interests, preferences, and/or experiences. The list may be customizable using any selection method.

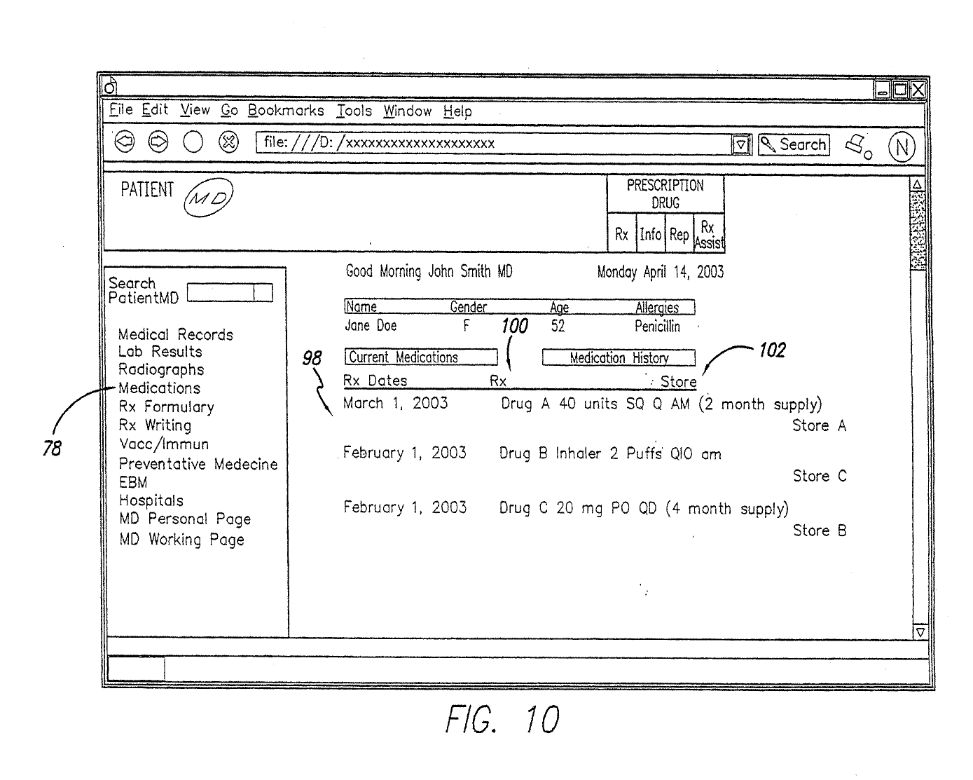

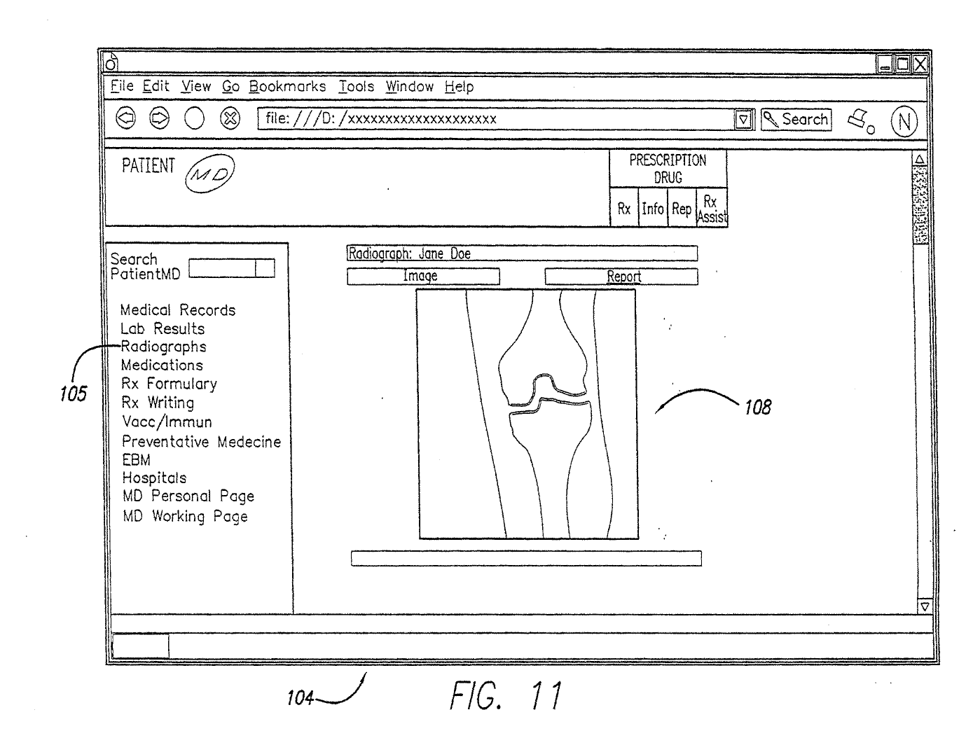

Referring now to FIG. 10, a physician-user can click on the medications link from the page selection link section 78 to view the patient's current medication listing which includes the prescription dates 98, the name of the prescribed drug 100, and the store or pharmacy supplying the drug 102. Similarly, FIG. 11 illustrates the patient's images or radiographs screen 104, accessible from the Radiographs link 105. A sample radiograph 106 is shown.

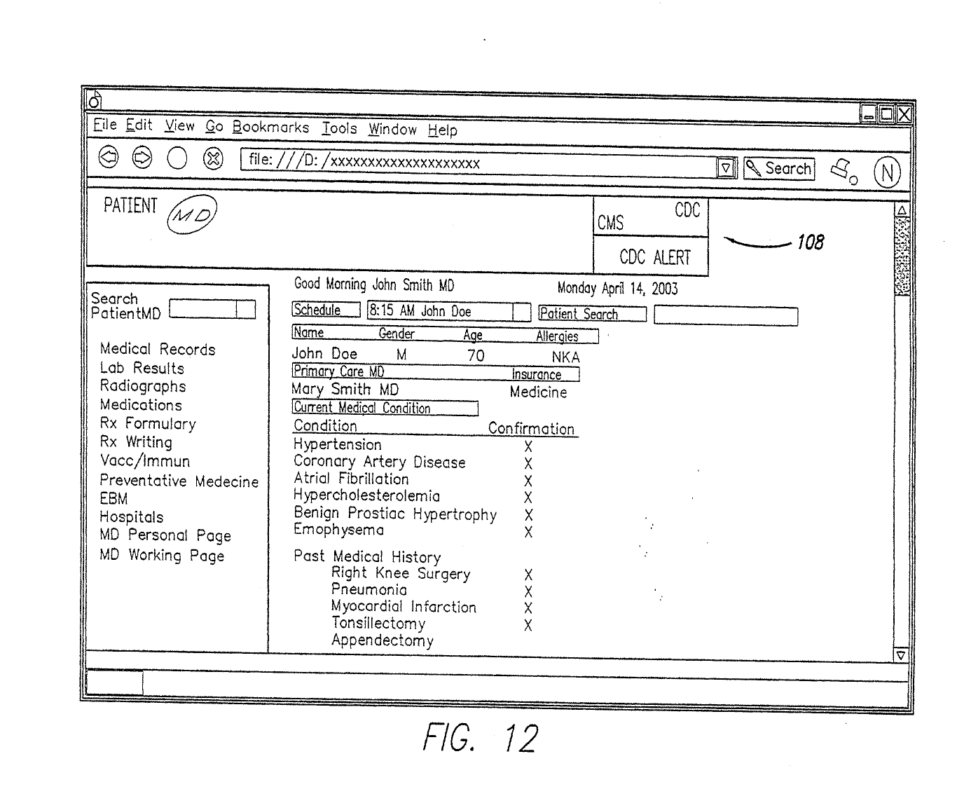

As shown in FIG. 12, the physician-user can also receive alerts from monitoring institutions which may include government institutions such as the CMS, CDC, or the National Electronic Disease Surveillance System (NEDSS) via an alert banner 108. These alerts may be generated by these agencies to alert all physicians should an emergency or crisis occur. Additionally or alternatively, the alert may be activated when one or more of the medical conditions shown for the current patient have been flagged or are otherwise being monitored by these institutions. For example, if the CDC is concerned that doctors are making misdiagnoses by confusing Severe Acute Respiratory Syndrome (SARS) with the flu, an alert may be generated whenever the flu is entered as a patient's medical condition. A doctor reviewing the alert may realize that a misdiagnosis has been made and change their prescribed treatment. This is useful for monitoring commonly misdiagnosed illnesses and other government-monitored illnesses. The alerts, upon issuance, may overwrite or be shown in addition to the banner ad 108 or information.

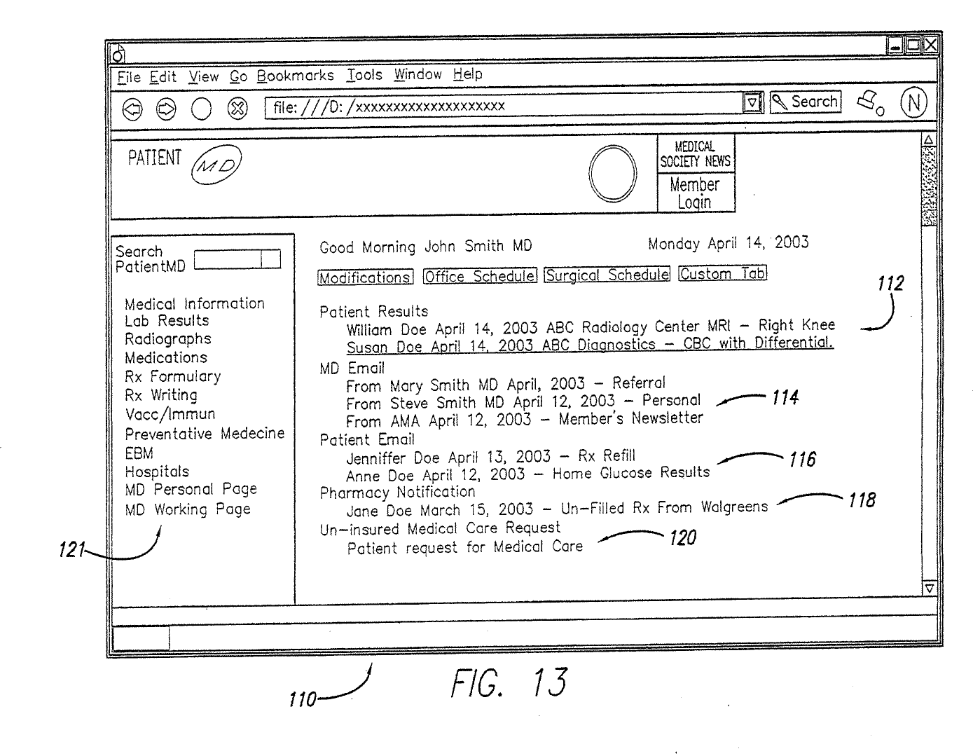

FIG. 13 illustrates an MD personal page 110 which shows a summary screen of the patient's lab results 112, email from other physicians 114, emails from patients 116, pharmacy notifications 118, and un-insured medical care requests 120. Messages to MDs from patients or other sources may be via text, voice, video, SMS technology, instant messaging, etc. In this manner, this system acts as a centralized communications tool for the physician-user. It is also envisioned that from the personal page 110, the physician-user can send mass emails to colleagues within a certain geographic region, such as within the same city or state. The left hand tabs 121 may correspond to either the physician's working page or the physician's personal page.

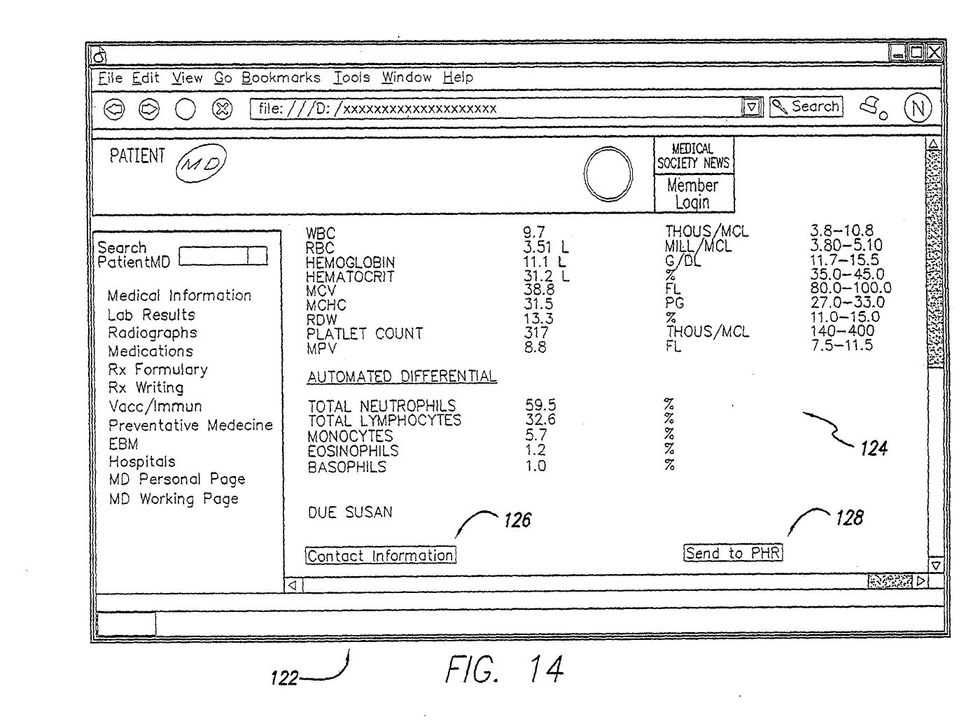

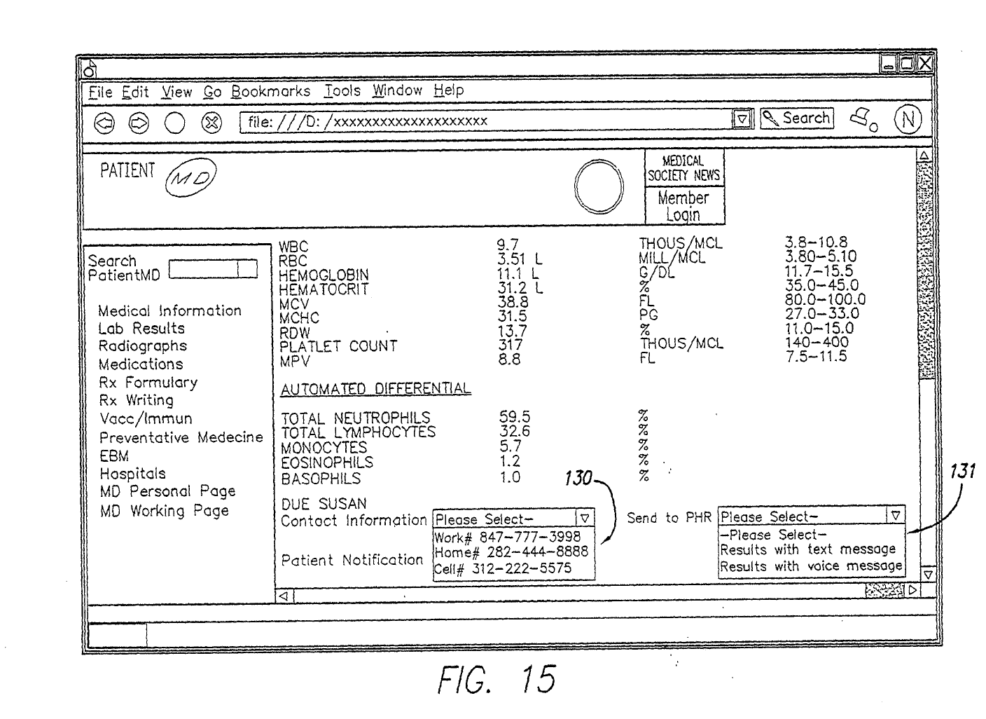

FIG. 14 illustrates an MD personal page 122. Personal page 122 contains the patient's lab results 124, as well as a contact information button 126 that causes the patient's contact information to be displayed when clicked. The personal page 122 also includes a “Send to PHR” button 128 that sends the lab result to the patient health record (PHR) stored on the repository 10 and accessible to the patient from the patient pages. FIG. 15 shows a drop down box 130 embodiment of the patient's contact information such as work, home, and cell phone numbers. Box 131 may also be used to send the patient's information to the patient's health record as a text message or using Voice over Internet Protocol (VoIP). Other contact information such as an email address may be displayed as well.

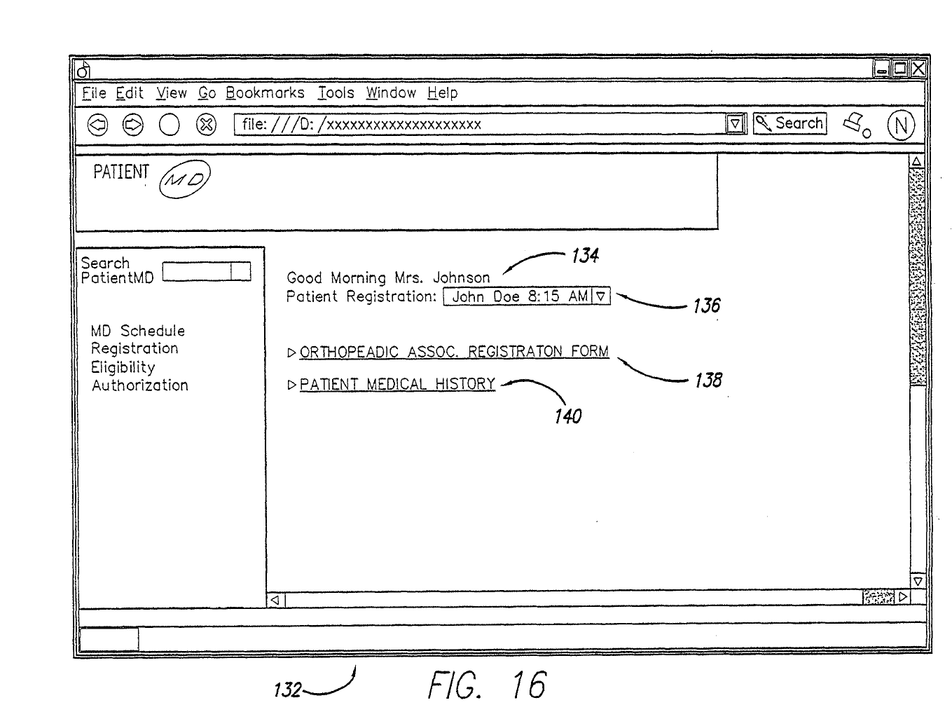

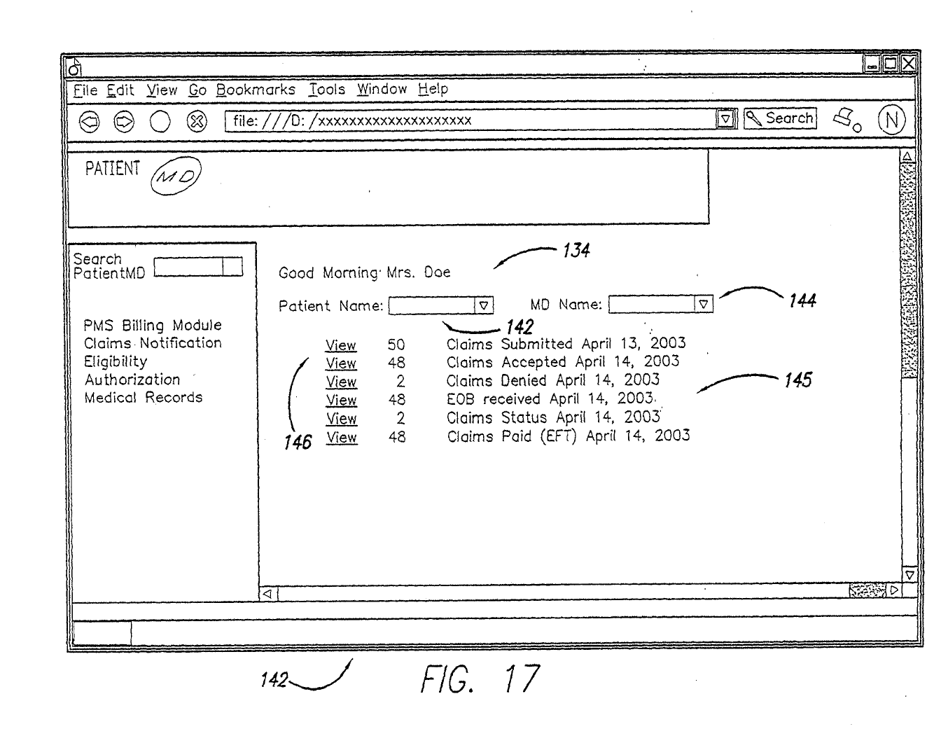

FIG. 16 illustrates an MD office staff registration page 132 which includes a greeting 134 for the office staff-user, a patient selector box 136 which may also include the patient's appointment time, a link to the registration form 138 for a particular hospital, and a patient medical history link 140. FIG. 17 illustrates an MD's office staff billing page showing a patient selection box 142, MD name selection box 144, and claims summary 145. Each claim also includes a view link 146 which forwards to a more complete view of a particular claim. This page allows for easy and convenient billing and administration of the patient. This page also provides functionality for registration, scheduling, billing, office manager tools, and information used by nurses and their assistants. The billing staff has access to patient medical records in a standard electronic format which can be used for justifying their claims with insurance companies. Also, a patient schedule from the registration page may be obtained from a practice management system use by the physician's office from this interface 132.

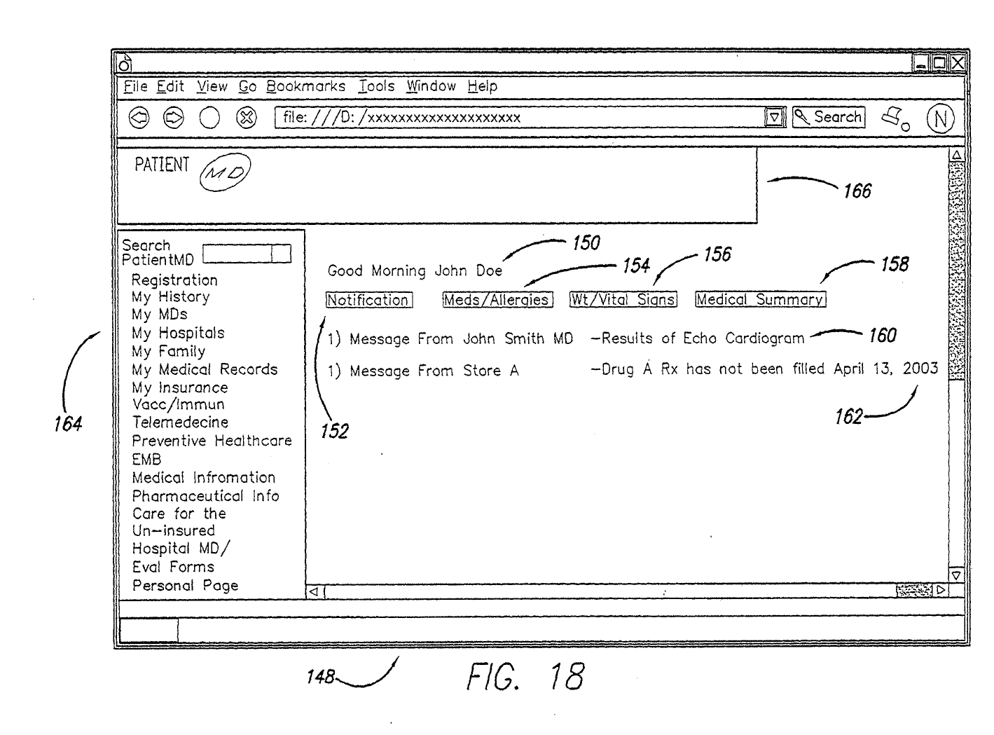

FIG. 18 illustrates a patient personal page 148. This page includes a greeting 150 for the patient as well as one or buttons to access certain categories of information such as notifications 152 from the doctor, medication and allergies 154 information, weight and vital sign information via button 156, and a medical summary button 158. The messages and notifications to patients from MDs or other sources may be via text, voice, video, SMS technology, instant messaging, etc. For example, specific educational/direct marketing material may be provided to the patient based on their clinical and demographic data via text, voice, video, SMS technology, etc. A sample message from a patient's doctor 160 and pharmacy 162 is shown. These messages and notifications may serve a variety of functions such as test result notification, doctor availability, whether a prescription is ready, whether the patient has forgotten to pick up a prescription, and so forth. Failed prescription notifications can be made to the physician-user as well. The patient page 148 also includes a link section 164 different than that found on the MD pages and an advertising banner 166 rather than the prescription-related banner found on the MD pages.

The patient health record page 148 also allows patients to receive marketing materials about health-related products such as pharmaceuticals, on an opt-in basis. A portion of monies received from advertisers when patients receive this information can be routed to charities of the patient's choosing. To make this selection, a patient is presented with a list consisting of charities that address or are attempting to cure the patient's ailment. For example, if the patient has a heart or cancer condition, donations would be routed the American Heart Association or the American Cancer Society.

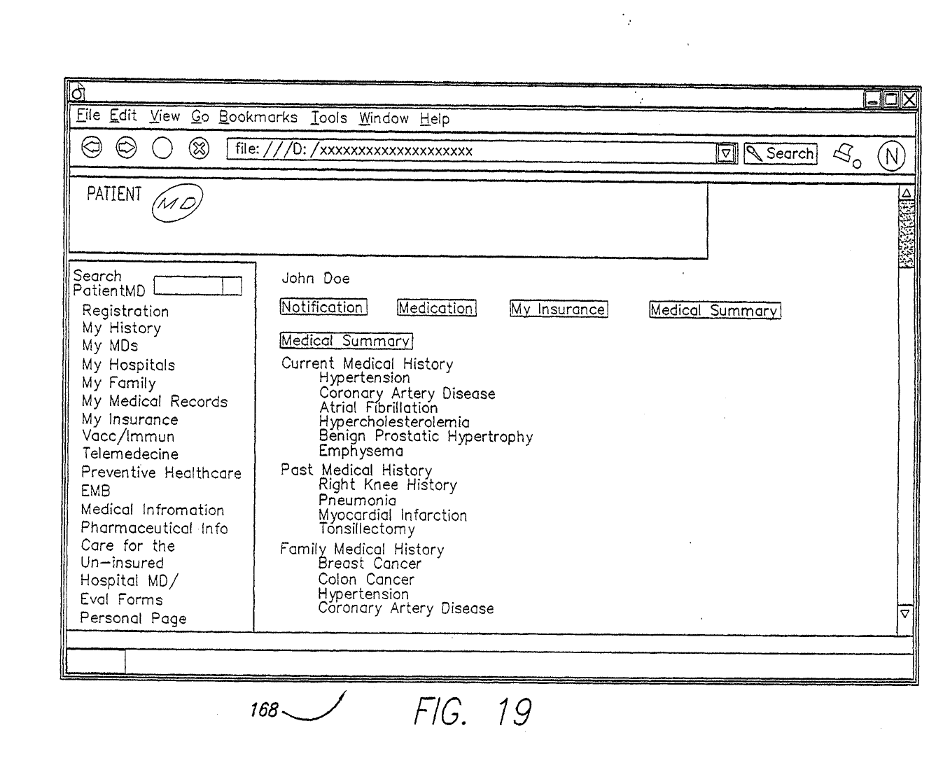

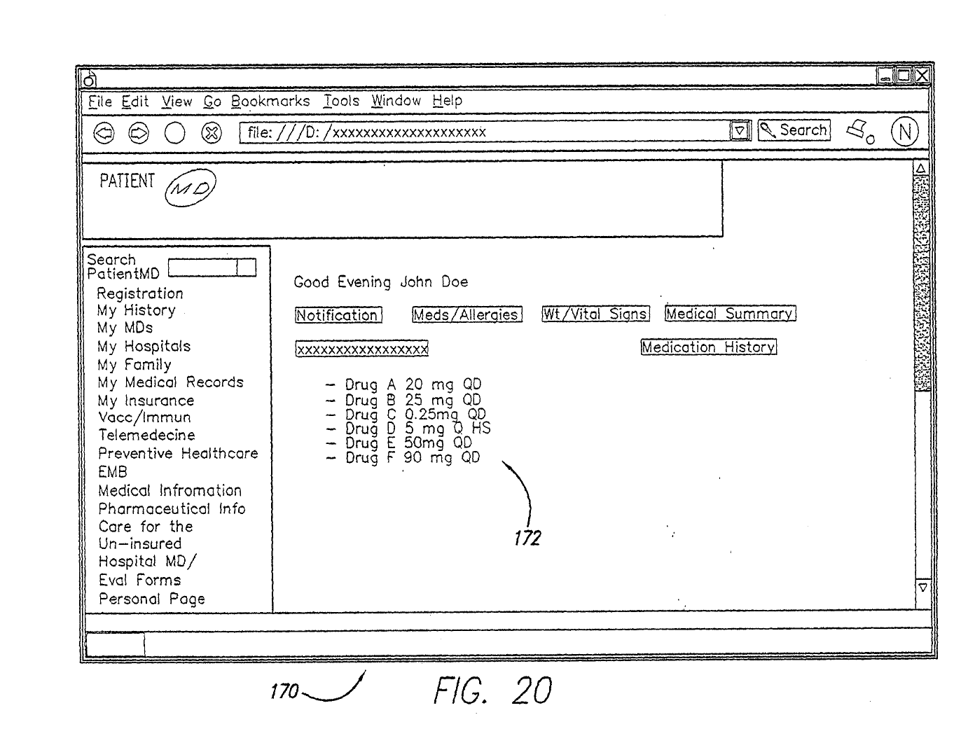

FIG. 19 shows a medical history page 168 viewable by the patient-user. This is the same information available the physician. Thus, the same information about current, past, and family medical histories is available to both a patient-user and the physician-user. Similarly, as shown in FIG. 20, a medication listing page 170 shows a listing of all currently prescribed medications 172 to the patient-user.

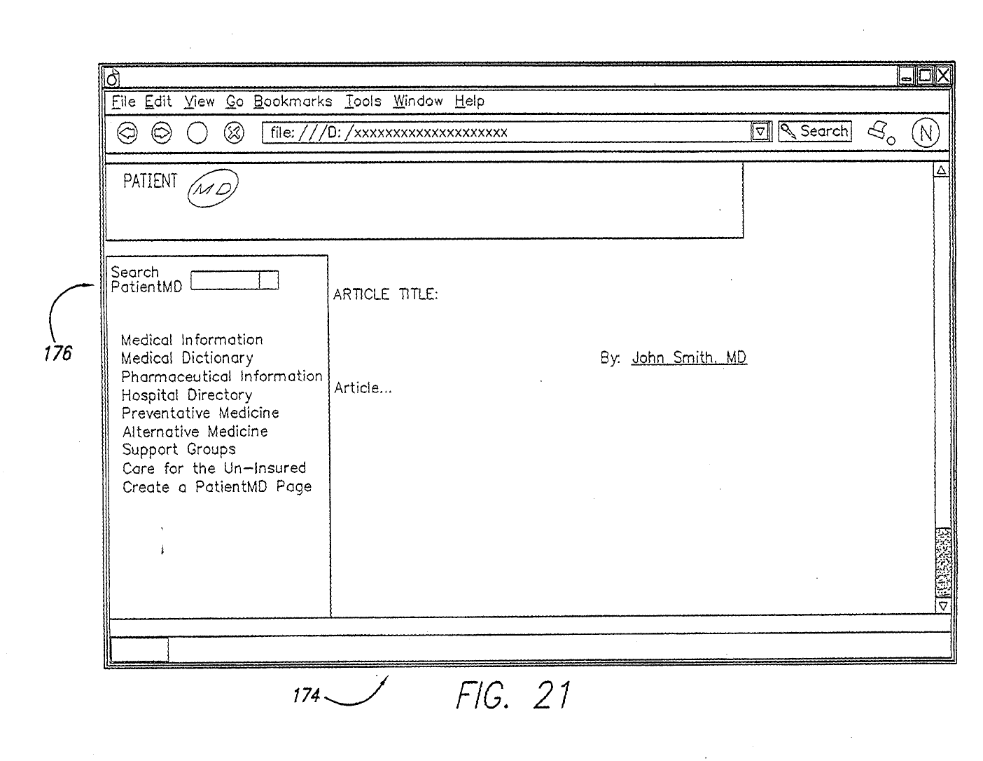

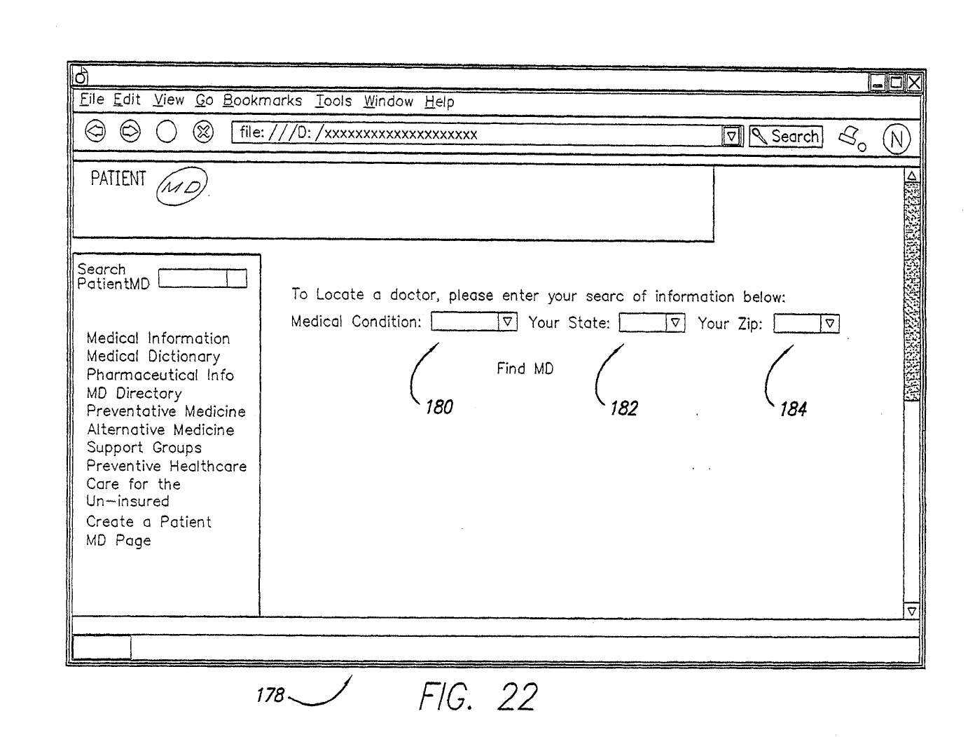

FIG. 21 illustrates a consumer portal page 174 which is used by visitors to the portal to perform general research about health-related topics. As shown in the consumer link section 176, this page 174 may include links to medication information, a medical dictionary, pharmaceutical information, a physician directory, information about preventative medicine, alternative medicine, support groups, information about care for the insured or to request care if the visitor is un-insured, and custom portal page creation page. FIG. 22 illustrates a web page 178 for locating a doctor offering services to the uninsured. Searches may be based the prospective patient's medical condition 180, state 182, zip code 184, or on a combination of these search parameters. It is envisioned that other search parameters related to the ailment, or other parameters related to prospective patient's location may be used as well.

Since the system communicates with clearing houses that handle MDs' claims submissions to the insurance companies, proponents of the current system may wish to work with Congress by providing MDs a tax write off or tax credit for physicians that provide care to the uninsured based on a, for example, Medicare fee schedule. If such a change in the law occurs, the current system may be found to be advantageous because the current system can monitor this type of information such as the number of hours provided to the uninsured at no cost.

Also, with the current system, physicians can share a contract management service that along with other services will provide physicians feedback about whether the physicians are getting paid consistently and appropriately by insurance companies.

The following additional functionality is also envisioned for the current system. Patients via their PHR can provide the cost, for comparison purposes, of various products and services that are considered commodities to the system. These products and services may include medications, laboratory services, imaging services, and medical products/devices. This database can be presented to other patient-users for cost comparison and/or shopping purposes. Similarly, the system can allow for information to be entered by physicians related to purchasing medical equipment and/or supplies that can be used within the office, hospital, and operating room. Physicians can also use the system's clinical infrastructure for gathering data, that has, for example, been “de-identified”, for use in conducting clinical trials for the pharmaceutical industry, such as by allowing physicians or experimenters to enter and review the de-identified data as it is being entered.

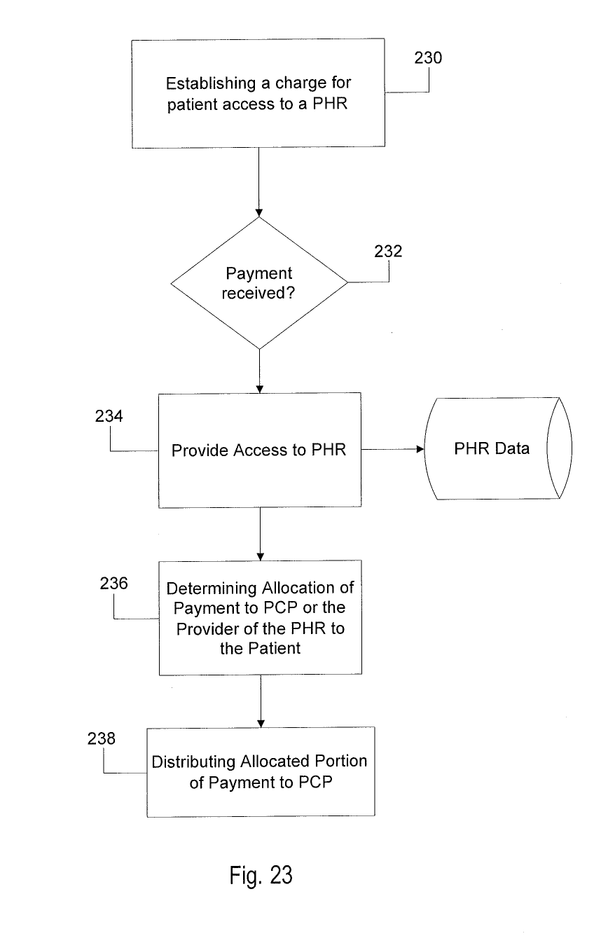

In one embodiment, the patient may be charged a fee for use of the PHR. FIG. 23 shows an example flow chart according to this embodiment. For example, a charge or fee could be established for patient access to the PHR. (Block 230). The fee could be charged to the patient in a variety of ways. For example, the fee could be charged on a periodic basis, such as monthly, quarterly or yearly. By way of another example, the fee could be charged based on the patient's access to the PHR. By way of a further example, a one-time fee could be charged to the patient for access to the PHR. The term “charged” is broadly intended to encompass an amount that is imposed, in whole or in part, on the patient to access at least a portion of the PHR. This means that the patient may not be responsible for the entire fee, but could be responsible for a co-pay charge to have access to the PHR. Embodiments are contemplated, for example, in which the patient's insurance company or employer could pay the fee in whole or in part. Upon receipt of the payment (Block 232), the patient would be provided with access to the PHR. (Block 234). As discussed above, the PHR provides access to a wide variety of features. In one embodiment, a different fee could be charged for access to different features available in the PHR. In such an embodiment, the patient could be presented with an “ala carte” menu of PHR features from which to choose, some of which may have varying fees or be free to access.

Embodiments are contemplated in which the fee charged to the patient for access to the PHR could be allocated among a plurality of entities. For example, the PHR may be provided to the patient from one of a plurality of the patient's health care providers for the fee. However, a portion of the fee will be allocated to the designated primary care physician of the patient, regardless of who issued the PHR to the patient. (Block 236). The allocated money from the PHR may be distributed to the primary care physician or the provider of the PHR or any other physician within the PatientMD network 18. This allocated amount would be distributed to the primary care physician. (Block 238). Consider an example in which a hospital provides a patient with access to a PHR for a monthly fee of $10.00. In this example, the patient's primary care physician may be allocated $2.00 of the monthly fee. This creates a strong incentive for the patient's primary care physician to join the network, which increases use of the system.

In one embodiment, an allocation module may be associated with the PHR. The allocation module, which would execute on a processor, may be configured to allocate the fee received from the patient between a plurality of entities, including the patient's designated primary care physician. In some cases, the allocation module may include data setting forth the amount (which could be based on a percentage or flat amount) that will be allocated to the patient's primary care physician. For example, the allocation module could be configured to make a payment to the patient's designated primary care physician based on the allocated amount.

In another embodiment, the patient may be provided with an interoperable EHR/PHR in which the patient would have full control of their data. For example, the patient could control the extent to which health care providers would have access to information in their EHR/PHR. Likewise, the patient may be able to control access by third parties, such as family members, to their EHR/PHR.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicants have provided description and figures which are intended as illustrations of embodiments of the disclosure, and are not intended to be construed as containing or implying limitation of the disclosure to those embodiments. There is a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure and the appended claims.

What is claimed is:

1. A computerized method for allocating payments for access to a computer system, the method comprising the steps of:
storing a personal health record (“PHR”) of a patient including a plurality of records with medical information concerning the patient in a database, wherein the database includes at least one record identifying a primary care physician (“PCP”) of the patient;
establishing a charge for patient access to the PHR, wherein the patient is required to pay at least a portion of the charge;
providing the patient with access to the PHR over a communication network after receipt of a payment;
determining an allocation of the payment between a plurality of entities including the PCP of the patient, wherein the PCP or provider that provided the PHR to the patient is allocated at least a portion of the payment regardless of whether the PCP issued the PHR to the patient; and
paying the PCP the portion of the payment allocated to the PCP.

2. The method of claim 1, wherein at least one of the patient's employer or insurer is required to pay at least a portion of the charge for patient access to the PHR.

3. The method of claim 1, further comprising the step of presenting a list of a plurality of features available in conjunction with the PHR from which the patient can select.

4. The method of claim 3, further comprising the step of establishing a charge for at least a portion of the features available in conjunction with the PHR, wherein the patient is provided with access to a selected feature after receipt of payment for the feature.

5. The method of claim 4, wherein at least a portion of the features are free of charge and the patient is provided access upon selection without any payment.

6. The method of claim 4, further comprising the step of determining an allocation of the payment for respective features between a plurality of entities including the PCP of the patient, wherein the PCP is allocated at least a portion of the payment regardless of whether the PCP issued the PHR to the patient and paying the PCP the portion of the payment allocated to the PCP.

7. The method of claim 1, further comprising the step of providing an interface for a health care worker of the patient to input data into the PHR of the patient.

8. The method of claim 1, further comprising the step of providing an interface for a health care worker of the patient to communicate a message to the patient via the PHR.

9. The method of claim 8, wherein the message is at least one of a test notification or doctor availability.

10. The method of claim 9, wherein the message comprising one or more of text, audio, video and instant messaging.

11. The method of claim 1, further comprising the step of providing an interface for a health care worker of the patient to communicate a message to another health care worker of the patient via the PHR.

12. The method of claim 11, wherein the message comprises one or more of text, audio, video and instant messaging.

13. The method of claim 1, further comprising an interface configured to allow communication between one or more of the patient, health care workers of the patient, and other participants within a network of the patient.

14. The method of claim 13, wherein the message comprises one or more of text, audio, video and instant messaging.

15. The method of claim 1, further comprising the step of displaying an advertising banner to the patient in the PHR, wherein the PHR includes an interface configured to allow selection by the patient of a charitable organization to whom a portion of the proceeds from the advertising banner are distributed.

16. The method of claim 15, wherein the interface is configured to display a list of charitable organizations corresponding with one or more conditions in the patient's PHR.

17. The method of claim 1, wherein the PHR includes a medical history page with medical information about the patient.

18. The method of claim 17, wherein the medical history page is viewable by the patient and at least one health care worker of the patient.

19. A computerized personal health (“PHR”) record system comprising:
a repository server including a personal health record (“PHR”) of a patient including a plurality of records with medical information concerning the patient in a database, wherein the database includes at least one record identifying a primary care physician (“PCP”) of the patient;
a web-based communication interface adapted to receive health-related information from the repository server over a communication network, wherein the web-based communication interface includes a patient health record section;
computer-executable instructions for performing steps comprising:
establishing a charge for patient access to the PHR, wherein the patient is required to pay at least a portion of the charge;
providing the patient with access to the PHR over a communication network after receipt of a payment;
determining an allocation of the payment between a plurality of entities including the PCP of the patient, wherein the PCP or the provider who issued the PHR to the patient is allocated at least a portion of the payment regardless of whether the PCP issued the PHR to the patient;
paying the PCP the portion of the payment allocated to the PCP;
a processor for executing the computer executable instructions; and
a memory for storing at least the computer executable instructions.

20. The method of claim 19, further comprising instructions for establishing a charge for at least a portion of the features available in conjunction with the PHR, wherein the patient is provided with access to a selected feature after receipt of payment for the feature.
